(19) United States
(12) Patent Application Publication
(10) Pub. No.: US 2025/0353685 A1
(43) Pub. Date: Nov. 20, 2025

(54) SYSTEM FOR OPTIMIZED USE OF A SORTING CONVEYOR, IN PARTICULAR A POUCH SORTER CROSS-REFERENCE TO RELATED APPLICATION

(71) Applicant: BEUMER GROUP GMBH & CO. KG, Beckum (DE)

(72) Inventor: David BAUER, Graz (AT)

(21) Appl. No.: 19/202,302

(22) Filed: May 8, 2025

(30) Foreign Application Priority Data
May 17, 2024 (EP) 24176485.1

(51) Int. Cl. B65G 1/137; G06Q 10/087; G06Q 30/0202

(52) U.S. Cl. CPC B65G 1/1376; G06Q 10/087; G06Q 30/0202

(57) ABSTRACT

The present invention relates to a system for the optimized use of a sorting conveyor, in particular of a pouch sorter, having a sorting conveyor which is set up to assemble items to form packing orders corresponding to customer orders, wherein the sorting conveyor has a buffer for the intermediate storage of items, and wherein the buffer can be connected in terms of conveying technology to a goods store; and a system control device.

### CROSS-REFERENCE TO RELATED APPLICATION

This application claims the benefit and priority of European Patent No. 24176485.1 filed May 17, 2024. The entire disclosure of the above application is incorporated herein by reference.

### BACKGROUND OF THE INVENTION

### Technical Field

The invention is based on a sorting conveyor which is set up to assemble articles into packing orders corresponding to customer orders, wherein the sorting conveyor has a buffer for the intermediate storage of articles, and wherein the buffer can be connected to a goods store via an interface, wherein articles can be transferred between the buffer and the goods store at the interface. Such a sorting conveyor is known, for example, from document DE 10 2018 209 266 A1. A system for optimized use of a sorting conveyor having the features of the preamble of claim 1 is known from WO 2023/272321 A1. Further systems are described in EP 3 213 274 B1 and EP 4 258 195 A1.

### Discussion

However, the known sorting conveyor has the disadvantage that the buffer is loaded with the ordered articles only after receipt of specific customer orders or is/can be used as a storage area only to a limited extent or not at all with regard to cost efficiency. In addition, the incoming customer orders are first accumulated in the enterprise resource planning module before they are forwarded to the warehouse management system or control module of the goods warehouse or of the sorting conveyor, with the result that, even from the point of view of maintaining a desired time from receipt of an order to delivery of the goods to the customer, a very large processing volume for the goods transfer between goods warehouse and sorting conveyor temporarily occurs and the processing volume at other times is very low.

It is therefore an aspect of the invention to provide a system for optimized use of a sorting conveyor, by means of which the loading of the buffer can take place more uniformly.

### SUMMARY

Accordingly, it is provided that the system has a system control device which is set up to:
determine or obtain an article demand expected for a future time period;
and prompt the transfer of the items corresponding to the expected article demand from the goods store to the buffer.

In this case, the algorithm can be set, for example, in such a way that items are already transferred into the buffer in the case of a slight order probability.

It can further be provided that the system control device is further configured to:
determine the items actually required for the time period on the basis of customer orders received;
compare the actually required items with the items located in the buffer in order to determine the missing items for fulfilling the customer orders received;
and initiate the transfer of the missing items from the goods store to the buffer.

The advantages of the invention and in particular of the forecasting of items ordered in the future consist in that the logistics provided for the transfer of items from the goods store to the sorting conveyor can be utilized more uniformly. As a result, load peaks are avoided and workforces are used more efficiently and/or saved. Furthermore, the planning effort for operations managers is reduced, since the effort for the coordination of work sequences is reduced. Furthermore, by means of the more uniform utilization, workstations can be reduced which previously had to be kept available for handling load peaks. A further great advantage consists, by means of the early loading of the buffer already before order receipt or a continuous filling of the pouch sorting system, in an improved resource utilization and a significant shortening of order throughput times and in an associated reduction of the waiting time for the consolidation of the items required for handling the customer orders in the buffer. Furthermore, by means of the combination of the use of an intelligent order and/or demand forecast software/AI (for example an AI with the intention of forecasting the orders for an upcoming period) and, for example, a module of a pouch sorting system intended for storing single piece items in a pouch, the advantage lies in a better overall utilization of the storage system and order management. Overall, as a result of the potential saving of order-picking areas for pre-order picking and the possibility of saving personnel, the invention additionally enables a great cost-saving potential.

The buffer can be connectable in terms of conveying technology to a goods store in such a way that, for example, an interface is provided between the goods store and the buffer, at which interface a transfer of items from the goods store to the buffer can take place. For example, the goods store can have its own conveying technology, by means of which the interface can be approached. The buffer can also have its own conveying technology, by means of which the interface can be approached. The transfer of items at the interface can take place automatically. Furthermore, the transfer of items at the interface can take place by personnel. For example, the buffer can be integrated in terms of conveying technology into a pocket sorter which has a multiplicity of transport pockets. Loading of the transport pockets with items from the goods store can take place at the interface, preferably in each case one item being loaded into a transport pocket in this case. The system can furthermore have a loading station, which is arranged at the interface between the goods store and the sorting conveyor, for loading the transport units of the sorting conveyor with items from the goods store. Pouch in this case, the loading station can be connected in terms of conveying technology to the buffer. Alternatively, it can be provided that the goods store and the buffer are connected to one another via a common conveying technology.

The determination of the item demand expected for a future time segment can be brought about by using software which is set up to generate an intelligent prediction/order prediction etc. As a result, the buffer, which serves mainly for the consolidation of pre-commissioned orders in the prior art, can continue to be used cost-efficiently as a storage system. The system can be set up to determine the expected item demand automatically. Alternatively, it can be provided that the data relating to the expected item demand are obtained from an external system. The data can be obtained, for example, from an external ERP system. The external data can be sent to the system control device using an interface, for example an API. It can be provided, for example, that the determination of the expected item demand is obtained as an external service and is transmitted to the system control device.

Order prediction relates to the prediction of customer orders or purchases. It is a prediction about which products customers are likely to purchase next, for example based on their previous purchasing behavior, their preferences and other relevant data. Order prediction is often used in e-commerce platforms in order to generate personalized recommendations for customers and to improve the shopping experience. Thus, for example, it can be provided that the system control device is set up to determine the item demand expected for a future time segment from customer order details collected in past time segments, in real time and/or in forecasts. In this case, all conceivable available data can be included. For example, it can be taken into account if a prominent personality orders, for example, a red T-shirt, or the weather prediction for the coming days. The software can be based on or have an AI algorithm.

It can be provided that the expected item demand is determined on the basis of at least one of the following data sources: sales and revenue data, visitor data, traffic sources, product services, customer behavior, historical sales data, customer behavior, inventory data, price developments, seasonalities, marketing activities and/or trends from the Internet.

Furthermore, it is conceivable that the determination of the item demand expected for a future time segment takes place on the basis of at least one of the following steps:
obtaining real-time data, loading the real-time data, defining features and/or target variables, dividing the data into at least one training set and at least one test set, creating and training a model, making predictions, comparing the predictions with actual values.

An algorithm can be provided for the determination of the item demand expected for a future time segment, which algorithm is set up by machine learning and/or artificial intelligence to optimize the accuracy of the expected item demand.

The determination of an expected item demand for a future time segment can take place continuously. Alternatively, the determination of the expected item demand for a future time segment can take place periodically.

It can be provided that the system control device is set up to initiate the transfer of the items corresponding to the expected item demand of the future time segment from the goods store to the buffer before the corresponding customer orders have been received completely.

The sorting conveyor can be set up to assemble the packing orders corresponding to the customer orders from the items located in the buffer. The assembly can take place in such a way that the corresponding items are unloaded at a predetermined end point. For this purpose, all the pockets which contain items of the corresponding packing order can pass through the end point and can be actuated and/or manipulated there in such a way that an openable pocket base, formed by two side walls and connected by a coupling, is opened at the end point, with the result that the item is unloaded from the pocket at the end point. The couplings of the pockets can be designed in such a way that they automatically close the pocket base again after the unloading. For the unloading, the sorting conveyor can have at least one unloading station which serves for unloading the items corresponding to a respective packing order. The unloading station can further be set up to open the pocket base of the pockets and/or to close it again.

The system can further be set up to feed item returns into the buffer. As a result, unnecessary manual work steps can be avoided, since the returns can again be taken into account directly from the buffer for incoming packing orders without having to be sent back to the goods store or picked up again.

The system control device is further set up to initiate the transfer of at least a part of the items not required for the time period after processing the customer orders from the buffer back to the goods store. The return can relate in particular to those items in the buffer which were not predictably forecasted again for a future customer order. In contrast, it can be provided that items forecasted again remain in the buffer.

It can be provided that the buffer is part of the sorting conveyor. The buffer can have a plurality of sorting loops, wherein a predetermined number of transport units, in particular transport pockets, can be temporarily stored in each of the sorting loops. The buffer can further be designed to be scalable. The buffer can in this respect be set up to temporarily store a plurality of transport units which are each set up to receive individual items.

The system control device can be a module which transmits data and/or commands to an ERP, a WMS or material flow computer. The system control device can alternatively have a plurality of modules which can be set up to control and/or manage certain subfunctions of the system. For example, a company resource planning module can be provided which can be set up to receive and process the customer orders. Furthermore, the system control device can have a warehouse management system for managing the goods store which can be set up to receive information on the items corresponding to the customer orders from the company resource planning module. The system control device can further have a control module which can be set up to control the goods store and/or the buffer and/or the sorting conveyor. The control module can be set up to process information on the items corresponding to the customer orders received from the warehouse management system and/or the company resource planning module in such a way that the conveying technology of the goods store and/or the buffer and/or the sorting conveyor is actuated in such a way that the corresponding items are ultimately unloaded as a packing order at a certain end point of the sorting conveyor.

A corresponding operating sequence of the system can accordingly provide that firstly a first plurality of items which are to be provided at the interface between goods store and buffer is determined by the software for predicting customer orders, wherein corresponding information can be transmitted to the control module for controlling the goods store and/or the buffer and/or the sorting conveyor in order to cause the conveying technology to be provided at the interface. Subsequently, a second plurality of items is determined which results from the difference between the first plurality of items and the items actually ordered by customer order. This second plurality can then likewise be provided at the interface or the conveying technology can be caused to be provided. It can then be provided that the items are transferred manually and/or by an automated storage and provision system at the interface to the buffer or the sorting conveyor. The sorting conveyor can then assemble the respective packing orders from the items located in the buffer and unload them at respective end points. The end points can be located in a packing region in which the packing orders can then be packed and prepared for delivery.

The run-through time of an order is shortened by the system. By means of a continuous filling of the pouch sorting system, the system has an improved resource utilization. The cut-off time can be set later, so that the order is earlier for the end consumer. The overall run-through time can be drastically reduced. If the order demand can be predicted, it is possible to employ fewer employees constantly with the pre-order picking instead of employing many employees to handle the peaks. If it is necessary to deal with returns and the function of the order prediction is available, “good” returns can be left in the buffer and “poor” returns (not required) can be removed from the buffer earlier in order to free up valuable space for the predicted, actual demand.

### BRIEF DESCRIPTION OF THE DRAWINGS

Further details of the invention will be explained with reference to the following figures. In the figures:

FIG. 1 shows a flowchart of the operating sequence of an exemplary embodiment of the invention;

FIG. 2 shows a flowchart of the operating sequence of a system known from the prior art;

FIG. 3 shows a flowchart of the operating sequence of a system known from the prior art;

FIG. 4 shows a flowchart of the operating sequence of an exemplary embodiment of the invention;

FIG. 5 shows a flowchart of the operating sequence of an exemplary embodiment of the invention.

### DESCRIPTION OF THE PREFERRED EMBODIMENTS OF THE INVENTION

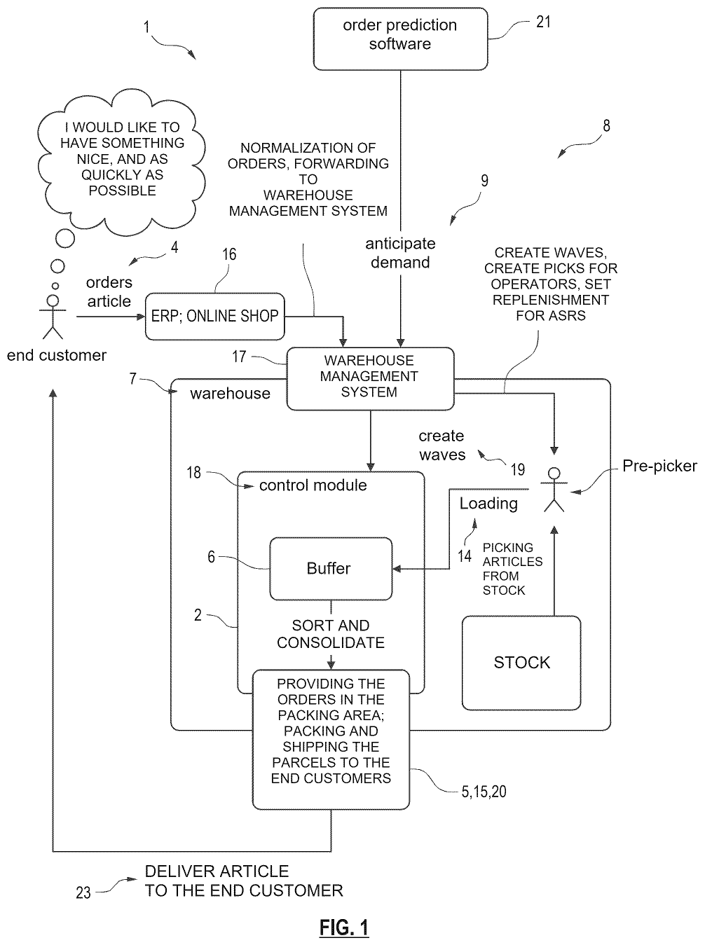

FIG. 1 shows, by way of example, a flowchart of the operating sequence of an embodiment of the invention. In this case, an end customer orders a number of items via an online shop within the scope of a customer order 4. The online shop is connected to a company resource planning module (ERP) 16 which serves for accepting and managing customer orders. The information relating to the actually ordered items 3 is transmitted from the ERP 16 to a warehouse management system 17. The total quantity of all items 3 ordered within a definable time period from a multiplicity of customer orders 4 results in the items 11 actually required for the time period. Already previously, it was already forecasted by order forecasting software 21 which items (type, quantity, number) are likely to be demanded in the time period, from which a total quantity of forecasted items 10 is determined. As a result of the forecasting of items 3 ordered in the future and the associated early introduction of the corresponding goods into the buffer 6, a normalization of orders arises, the transfer logistics between goods store 7 and sorting conveyor 2 can be utilized uniformly without peak loads occurring, as in the prior art, for which more resources such as personnel and/or planning effort would have to be provided. In the warehouse management system 17, the forecasted items 10 and the actually ordered items 11 are accumulated and, for example, the corresponding information is transmitted to the control module 18 in waves 19. The control module 18 causes the conveying technology of the goods store 7 to provide the items 3 at a loading station 14 which is arranged at an interface between goods store 7 and sorting conveyor 2 or buffer 6. The automatic and/or manual loading of the transport units of the sorting conveyor 2 with individual items 3 takes place at the loading station 14. The control module 18 subsequently causes the transfer of the transport units from the loading station 14 to the buffer 6. In the sorting conveyor 2, the items 3 located in the buffer 6 are sorted or assembled to form packing orders 5 which each correspond to one of the customer orders 4. At an unloading station 15, the items 3 of a packing order 5 are unloaded and packed or prepared for dispatch. After order release 20, the parcels are delivered to the end customer.

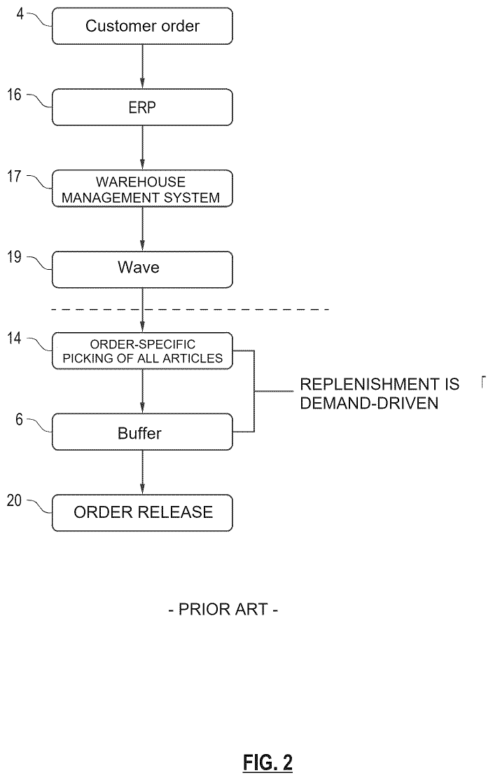

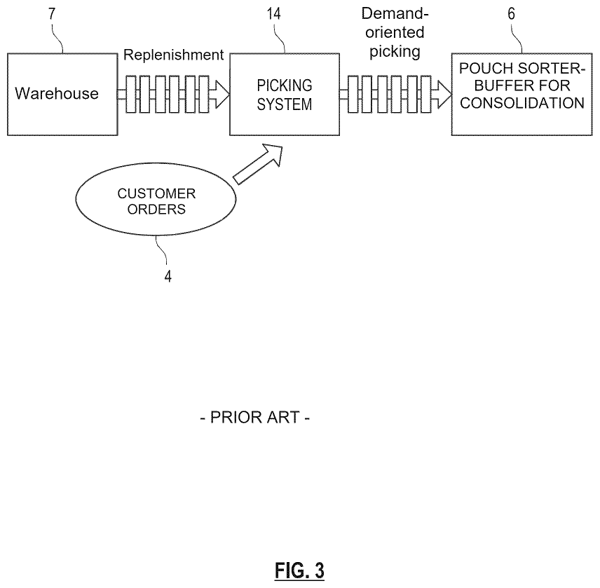

By contrast, FIGS. 2 and 3 show a system known from the prior art for operating a sorting conveyor. This differs substantially from the system according to the invention in that no customer orders are forecasted and loading of the buffer 6 takes place only after the receipt of actual customer orders 4, and then consequently also only with the actually ordered items 11. In this regard, FIG. 2 shows the administrative sequence for operating the system. Firstly, customer orders 4 are received, which are made, for example, via an online shop and are fed via this into an ERP 16. The ERP subsequently notifies a warehouse management system 17 of the items 3 to be provided. The warehouse management system accumulates the items 3 and causes a control module 18 of a goods store 7 and/or sorting conveyor 2, for example, wave by wave, to transfer the corresponding items from the goods store 7 to the buffer 6. An order-specific picking of the required items 3 and the loading of transport units of the sorting conveyor 2 with the respective items takes place at a loading station 14. Subsequently, the transport units are fed into the buffer 6. An order release 20 triggers the assembly of packing orders 5 corresponding to the customer orders 4 in the sorting conveyor, the unloading of the items at an unloading station 15 and the packing of the items 3 and the dispatch of the packed parcels.

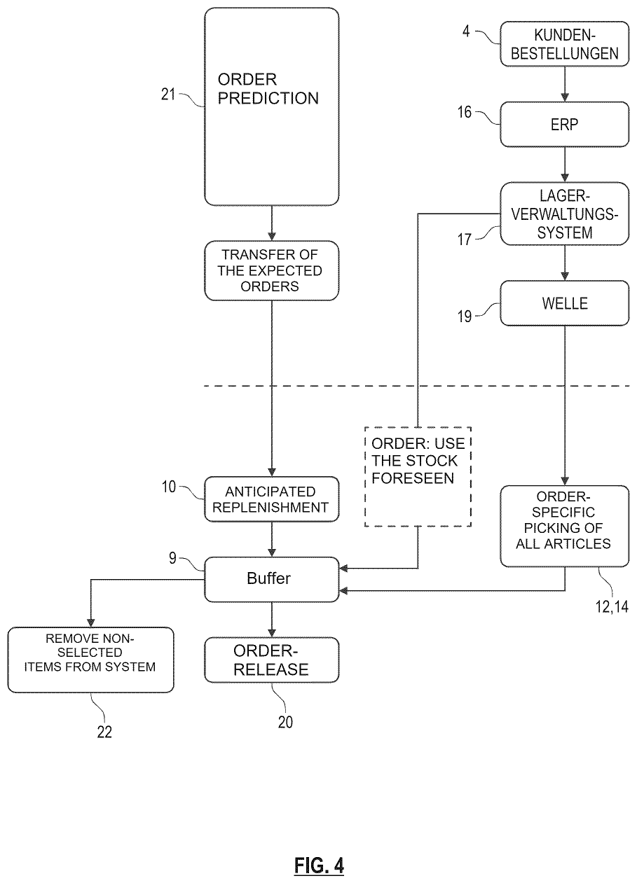

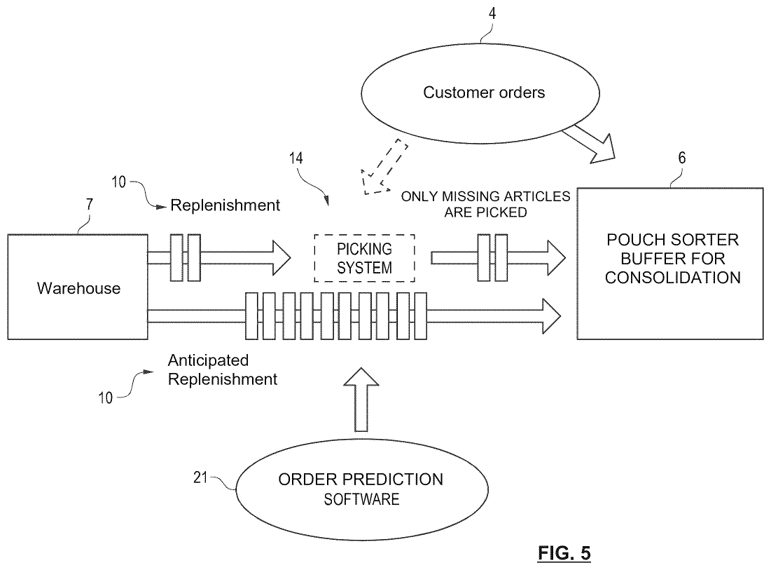

An embodiment of the system 1 according to the invention is illustrated in FIGS. 4 and 5. By contrast with the illustration in FIG. 2, FIG. 4 shows in particular the additional forecasting of an order prediction 21 and the transfer of the expected orders as an anticipated supply 10 to the buffer 6. Merely in addition, the items 12 still missing in the buffer 6 for fulfilling the customer orders 4 are then subsequently transferred from the goods store 7 to the buffer 6. For this purpose, the warehouse management system 17 calculates the difference between items already located in the buffer 6 or forecasted items 10 which are still on the way into the buffer 6 and the items 11 which were actually ordered, in order then to initiate the transfer of the still missing items 12 to the buffer 6. The system 1 according to the invention can further have the function that unselected items are removed from the buffer 6. These can be, for example, incorrectly forecasted items or items of orders cancelled in the meantime. In this case, it can be provided that, however, those of these items which were forecasted again for a future time segment or were actually ordered in the meantime by another customer remain in the buffer 6.

FIG. 5 shows clearly that the proportion of items 3 to be picked which were not forecasted but actually ordered is significantly reduced by the use of the order forecasting software 21. Since this proportion of missing items 12 has to be transferred particularly quickly from the goods store 7 into the buffer 6 on account of the introduction into the buffer 6 which is possible only after receipt of the corresponding customer orders 4 in order to achieve a rapid delivery to the customer, this reduction has the advantage that the time between order and delivery can be greatly reduced and, in addition, a large amount of personnel or resource does not have to be kept available for handling this amount.

The features of the invention disclosed in the above description, in the drawing and in the claims can be essential both individually and in any desired combination for the realization of the invention.

What is claimed is:

1. A system (1) for the optimized use of a sorting conveyor (2), in particular of a pouch sorter, comprising:
a sorting conveyor (2) which is set up to assemble items (3) to form packing orders (5) corresponding to customer orders (4), wherein the sorting conveyor (2) has a buffer (6) for the intermediate storage of items (3), and wherein the buffer (6) can be connected to a goods store (7) via an interface, wherein items (3) can be transferred between the buffer (6) and the goods store (7) at the interface;
and having a system control device (8) which is configured to:
determine or receive an item demand (9) expected for a future time segment;
and initiate the transfer of the items (10) corresponding to the expected item demand (9) from the goods store (7) to the buffer (6).

2. The system according to claim 1, in which the system control device (8) is further configured to:
determine the items (11) actually required for the future time segment on the basis of customer orders (4) received;
compare the actually required items (11) with the items located in the buffer in order to determine the missing items (12) for fulfilling the customer orders (4) received; and
initiate the transfer of the missing items (12) from the goods store (7) to the buffer (6).

3. The system (1) according to claim 1, in which the system control device (8) is set up to determine the item demand (9) expected for a future time segment from customer order details collected in past time segments, in real time and/or in forecasts.

4. The system according to claim 1, wherein the expected item demand is determined on the basis of at least one of the following data sources:
sales and revenue data, visitor data, traffic sources, product services, customer behavior, historical sales data, customer behavior, inventory data, price developments, seasonalities, marketing activities and/or trends from the Internet.

5. The system according to claim 1, wherein the determination of the item demand (9) expected for a future time segment takes place on the basis of at least one of the following steps: obtaining real-time data, loading the real-time data, defining features and/or target variables, dividing the data into at least one training set and at least one test set, creating and training a model, making predictions, comparing the predictions with actual values.

6. The system according to claim 1, wherein an algorithm is provided for the determination of the item demand expected for a future time segment, which algorithm is set up by machine learning and/or artificial intelligence to optimize the accuracy of the expected item demand.

7. The system (1) according to claim 1, in which the determination of an expected item demand (9) for a future time segment takes place continuously.

8. The system (1) according to claim 1, in which the system control device (8) is set up to initiate the transfer of the items (10) corresponding to the expected item demand (9) of the future time segment from the goods store (7) to the buffer (6) before the corresponding customer orders (4) have been received completely.

9. The system (1) according to claim 1, in which the sorting conveyor (2) is set up to assemble the packing orders (5) corresponding to the customer orders (4) from the items located in the buffer (6).

10. The system (1) according to claim 1, in which the system (1) is further set up to feed item returns into the buffer.

11. The system (1) according to claim 1, in which the system control device (8) is further set up to initiate the transfer of at least a part of the items (13) not required for the time period after processing the customer orders (4) from the buffer (6) back to the goods store (7).

12. The system (1) according to claim 1, in which the buffer (6) is part of the sorting conveyor (2).

13. The system (1) according to claim 1, in which the buffer (6) is set up to temporarily store a plurality of transport units which are each set up to receive individual items (3).

14. The system (1) according to claim 1, which further has a loading station (14), which is arranged at an interface between the goods store (7) and the sorting conveyor (2), for loading the transport units of the sorting conveyor (2) with items (3) from the goods store (7).

15. The system (1) according to claim 14, wherein the loading station (14) is connected in terms of conveying technology to the buffer (6).

16. The system (1) according to claim 1, wherein the sorting conveyor (2) further has at least one unloading station (15) which serves for unloading the items corresponding to a respective packing order (5).

17. The system (1) according to claim 1, wherein the system control device (8) further has a company resource planning module (16) which is set up to receive and process the customer orders (4).

18. The system (1) according to claim 1, wherein the system control device (8) further has a warehouse management system (17) for managing the goods store (7) which is set up to receive information on the items corresponding to the customer orders (4) from the company resource planning module (16).

19. The system (1) according to claim 1, wherein the system control device (8) further has a control module (18) which is set up to control the goods store (7) and/or the sorting conveyor (2).
